(19) United States
(12) Patent Application Publication
(10) Pub. No.: US 2025/0232561 A1
(43) Pub. Date: Jul. 17, 2025

(54) TRANSFORMER FOR CLASSIFICATION

(71) Applicant: Microsoft Technology Licensing, LLC, Redmond, WA (US)

(72) Inventors: Vijay Srinivas AGNEESWARAN, Bangalore (IN); Badri Narayana PATRO, Bangalore (IN)

(21) Appl. No.: 18/411,823

(22) Filed: Jan. 12, 2024

(51) Int. Cl. G06V 10/764; G06V 10/77

(52) U.S. Cl. CPC G06V 10/764; G06V 10/7715

(57) ABSTRACT

A method may embed the input dataset into a first embedding space. A method may input the first embedding space into a spectral module including a periodic information processor and an aperiodic information processor. A method may identify global features in the input dataset using the periodic information processor based on a first subset of the first embedding space. A method may identify first local features in the input dataset using the aperiodic information processor based on a second subset of the first embedding space, wherein the first subset and the second subset are different. A method may combine the global features and the first local features into a dataset of classified features of the input dataset.

### BACKGROUND

In machine learning contexts, transformers can be used for natural language processing in large language models, computer vision, computerized medical image analysis, computer-based weather prediction, etc. A transformer is a deep learning architecture that can rely on multiple attention layers in a machine learning model. A transformer receives input data (e.g., in a dataset such as an image or text). The input data is split into tokens (e.g., pixels or patches of the image or words or phrases of the text). Each token is converted into a vector (e.g., via an embedding datastore). At each layer, each token is contextualized within the scope of a context window with other (unmasked) tokens via a multi-head attention mechanism, allowing the signals for key (more important) tokens to be amplified and the signals for less important tokens to be diminished.

Machine learning-based attention is a mechanism that mimics human cognitive attention, calculating dynamically adjustable weights for each token during each runtime. In one aspect, attention refers to the ability to dynamically identify the more important parts of the information in a dataset in a given context.

### SUMMARY

In some aspects, the techniques described herein relate to a method of classifying an input dataset, the method including: embedding the input dataset into a first embedding space; inputting the first embedding space into a spectral module including a periodic information processor and an aperiodic information processor; identifying global features in the input dataset using the periodic information processor based on a first subset of the first embedding space; identifying first local features in the input dataset using the aperiodic information processor based on a second subset of the first embedding space, wherein the first subset and the second subset are different; and combining the global features and the first local features into a dataset of classified features of the input dataset.

In some aspects, the techniques described herein relate to a computing system for classifying an input dataset, the computing system including: one or more hardware processors; an embedding processor executable by one or more hardware processors and configured to embed the input dataset into a first embedding space; a spectral processor executable by the one or more hardware processors and configured to input the first embedding space into a spectral module including a periodic information processor and an aperiodic information processor, wherein the periodic information processor is configured to identify global features in the input dataset based on a first subset of the first embedding space and the aperiodic information processor is configured to identify first local features in the input dataset based on a second subset of the first embedding space, wherein the first subset and the second subset are different; and an output interface executable by the one or more hardware processors and configure to combine the global features and the first local features into a dataset of classified features of the input dataset.

In some aspects, the techniques described herein relate to one or more tangible processor-readable storage media embodied with instructions for executing on one or more processors and circuits of a computing device a process for classifying an input dataset, the process including: embedding the input dataset into a first embedding space; inputting the first embedding space into a spectral module including a periodic information processor and an aperiodic information processor; identifying global features in the input dataset using the periodic information processor based on a first subset of the first embedding space; identifying first local features in the input dataset using the aperiodic information processor based on a second subset of the first embedding space; and combining the global features and the first local features into a dataset of classified features of the input dataset.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

Other implementations are also described and recited herein.

### BRIEF DESCRIPTIONS OF THE DRAWINGS

FIG. 1 illustrates an example system for classifying an image.

FIG. 2 illustrates an example transformer flow including multiple spectral layers and multiple attention layers.

FIG. 3 illustrates an example flow within an attention layer for capturing local feature information from a dataset.

FIG. 4 illustrates an example flow within a spectral layer for capturing local feature information and global feature information from a dataset.

FIG. 5. illustrates a model of an example system 50 for classifying a dataset a(x).

FIG. 6 illustrates example operations for classifying a dataset.

FIG. 7 illustrates an example computing device for use in implementing the described technology.

### DETAILED DESCRIPTIONS

Transformer models have enabled rich representation learning, at least in part due to efficient token mixing through an attention network (an example attention processor or attention layer). A transformer model generally assists in transforming one sequence of input into another depending on the problem statement (e.g., receiving an image as input and transforming it into a dataset including identified features in the image). These models learn the interactions among spatial locations using attention processing, but the complexity of attention processing increases quadratically as the dataset size increases (e.g., as the image size or text document size increases). Complexity can be reduced by merely reducing the size of the dataset (e.g., reducing the size and/or resolution of the image), but this approach also sacrifices the informational integrity of the dataset (e.g., losing potentially important information from the dataset). Furthermore, the nature of attention operation is to capture local token dependencies, often while facing difficulties in capturing global information.

Accordingly, the described technology provides an architecture for robustly capturing both global information (e.g., the outline of a human's head and shoulder in a portrait image) and local information (e.g., edges and linking lines between features) forming anatomical features in the portrait image, such as eyes, a nose, and a mouth) from a dataset to reduce transformer complexity without losing information from the dataset. The described technology combines spectral transformations with attention processing to capture both global information and local information from a dataset with lower computational complexity. In one implementation, for example, the spectral domain processing may combine a Hartley Transformation with a convolutional operator in the initial spectral layers with deeper attention layers of the classification system, at which point the dataset to processes is smaller than the initial dataset. In this manner, the described technology provides a technical benefit by reducing computational complexity for large datasets while retaining the informational integrity of each input dataset.

For example, in the case of clinical analysis of medical imaging, a high-resolution MRI image can be input into a machine learning model to diagnose tumors, lesions, and other medical conditions. A machine learning model employing the described technology, therefore, can perform the diagnosis more quickly (e.g., with less computational complexity) than in other approaches while retaining the fidelity of the high-resolution MRI image. Moreover, the described technology can also capture global information and local information to provide better, more complete diagnostics results as compared to other methods. As such, better diagnostic results can be obtained quickly without sacrificing important image data from the MRI image.

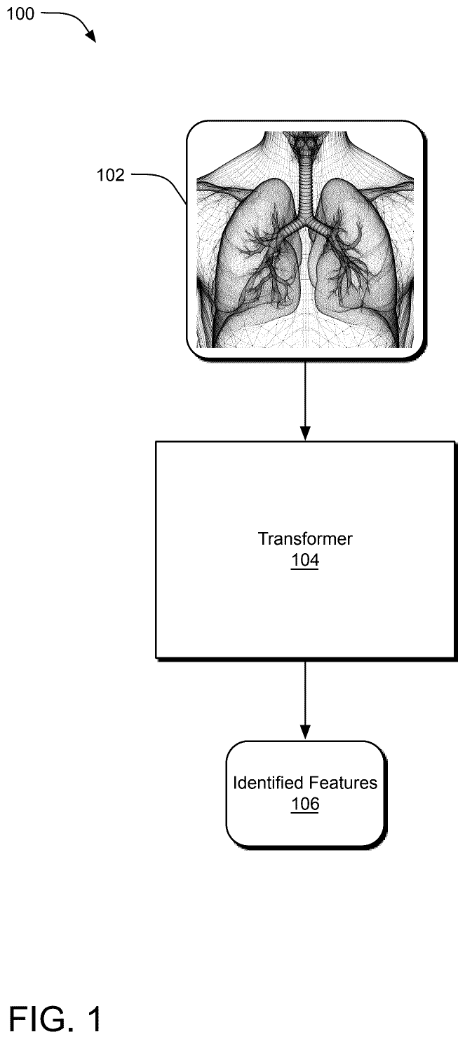

FIG. 1 illustrates an example system 100 for classifying an image 102. The image 102 in this example represents an input dataset that includes medical imaging data, although other types of data may be included in the input dataset, including weather data, drone data, satellite data, audio data, text data, seismic sensor readings, and other data containing discernable features. The system 100 inputs the image 102 to a transformer 104, which processes the image 102 and outputs identified features 106 of the image 102.

In various implementations, the transformer 104 includes a spectral layer (an example spectral processor) that processes periodic information to identify global features in the image 102 and/or processes aperiodic information to identify local features in the image 102. In other implementations, the transformer 104 also includes attention processing at deeper layers of the system flow that executes sequentially after the spectral transformation. As such, one or more attention networks, which can grow quadratically in computing complexity as the size of the input dataset grows (e.g., as the size and/or resolution of the image increases), operate on an intervening dataset that is smaller in size than the input dataset because the spectral processor has gated the data in initial layers and reduced the size of the data being processed by the attention processor. Furthermore, the spectral layers in some implementations have O(n*log(n)) complexity, which results in reduced overall complexity, both in terms of computation and number of parameters.

The identified features 106 includes a listing of identified features, such as tumors and lesions in medical imaging, faces and corresponding identities in video data, drought and flood conditions in satellite imagery, linguistic tokens in speech audio and text, etc. Further, the identified features 106 can be subdivided into at least two categories: (1) global features and (2) local features. In the context of machine learning models, the term “global features” refers to the features of a dataset that describe the dataset as a whole to generalize the dataset itself. Examples include contour representations, shape descriptors, texture features, etc. In contrast, the term “local features” refers to features that describe a specific part of a dataset. Examples include individual facial features of a human in an image and their placement relative to other individual local features, a localized low-pressure system in weather data, distinct terms in audio or text content, etc.

Attention networks that attempt to perform feature detection on an input dataset exhibit complexity challenges because the entire input dataset is processed by the attention network—the computational complexity of attention networks can grow quadratically with input dataset size. In contrast, the transformer 104 pre-processes the input dataset using one or more spectral processors (e.g., spectral layers), which reduces the size of the dataset being input to a subsequent set of one or more attention networks (e.g., attention layer 216, attention layer 218, attention layer 220, and attention layer 222). Furthermore, the spectral processors of the transformer 104 do not grow quadratically in computational complexity as the size of the input dataset grows. As such, with the reduction in size from the input dataset, the subsequent attention layers execute on a smaller dataset than the spectral processors, thereby reducing the overall computational complexity in classifying the input dataset.

In some implementations, the complexity of attention networks is O(n²) for n input tokens, and some transformers can include only attention layers, which leads to significant computational and memory complexity. By leveraging a few initial spectral layers, which have complexity O(n*log(n)), the overall complexity is reduced. In contrast, transformers without attention networks can limit the long-range dependency handling capacity. Moreover, spectral transformers that use Fourier transforms have a problem with complex-valued outputs, whereas the described spectral layers use the Hartley transform (combined with convolutional networks), which does not have complex-valued output. Thus, by introducing a new spectral layer, the described technology provides a technical benefit of reducing the computational complexity and number of parameters over other approaches.

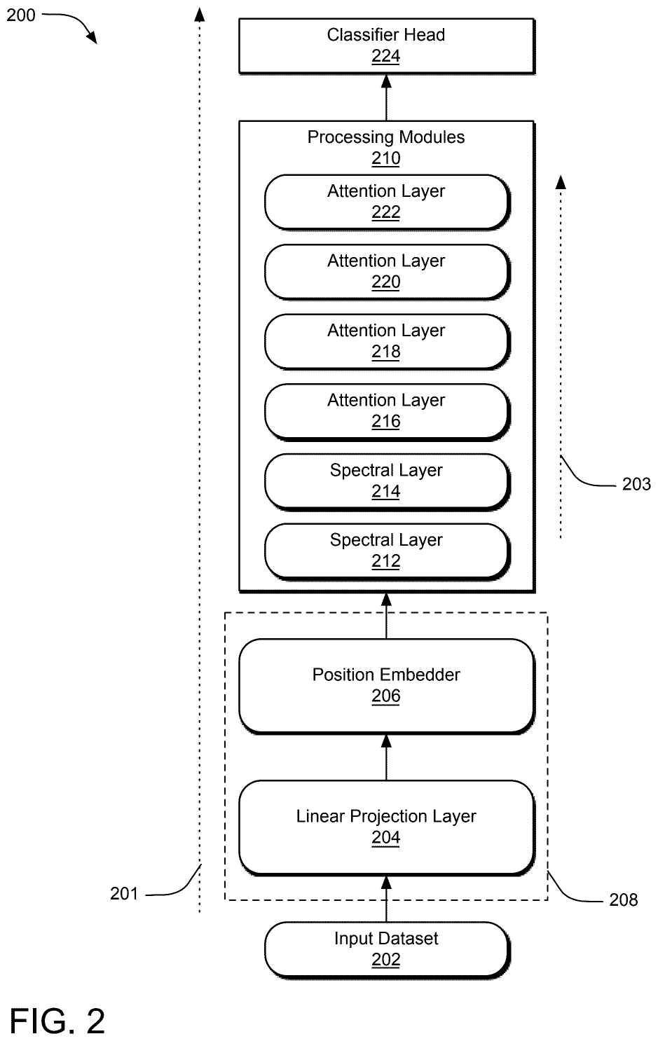

FIG. 2 illustrates an example transformer flow 200 including multiple spectral layers and multiple attention layers. The transformer flow 200 progresses in FIG. 2 from bottom to top, as indicated by a dashed arrow 201 showing the general flow and a dashed arrow 203 showing the flow through the processing modules specifically. An input dataset 202 (e.g., an image, text content, audio data, sensor data) is input to a linear projection layer 204, which is a type of neural network layer that projects a higher dimensional vector into a lower dimensional space. In one implementation, the linear projection layer 204 maps or translates “patch arrays” of the input dataset (e.g., small discrete regions of an image) into embedding vectors. Further, a position embedder 206 is a type of neural network that encodes or translates the positions of tokens in the input dataset 202 (e.g., the positions of patches in an input image) into the embedding vectors. Accordingly, the linear projection layer 204 and the position embedder 206 combine to provide an implementation of an embedding processor 208 that encodes dataset tokens and their respective positions into an embedding space for processing by a spectral processor, an attention processor, etc.

The embedding space is input to processing modules 210, which may include multiple spectral layers (e.g., spectral layer 212 and spectral layer 214) and/or multiple attention layers (e.g., attention layer 216, attention layer, 218, attention layer, 220, and attention layer 222), as shown in FIG. 2. It should also be understood that the spectral layers and attention layers may include a hierarchy of one or more sub-layers in some implementations. Furthermore, the number and position in the transformer flow 200 of specific spectral layers and attention layers may differ from that shown in FIG. 2, although, in most implementations, the spectral layers preceded the attention layers in the transformer flow 200.

The spectral layers represent individual spectral processors that operate in the spectral domain (e.g., the frequency domain) to identify features based on periodic and/or aperiodic input data. In contrast, the attention layers represent individual attention networks that operate in the spatial domain to identify features based on tokens and their relative positions within the input dataset. In various implementations of the described technology, the spectral layers process the embeddings of the input dataset prior to at least one attention layer of the transformer flow 200.

The flow of information is typically gated between each layer of the processing modules 210. Gating refers to a mechanism that selectively filters or modulates the input or output of a processing layer in a neural network. Gating is used to control the flow of information from layer to layer in the network by selectively allowing or blocking certain information. Gating contributes to a technical benefit of the described technology by first executing spectral processing (e.g., the spectral layers that do not exhibit the quadratic computational complexity growth with data size) on a larger set of input data and gating the data passed along to the attention processing (e.g., the attention layers that exhibit the quadratic computational complexity growth with data size). The model parameters or weights determine how much information will pass to the next layer. In this manner, some of the local and global feature identification may be performed with a lower computational complexity in the spectral layers, leaving additional local feature identification to be performed by the attention layers (having a higher computational complexity) on a smaller, gated dataset.

The output of the processing modules 210 is input to a classification head 224, which classifies the input dataset 202 based on the features identified by the processing modules 210. The classification head 224 can score and rank the identified features into a dataset of identified features of the input dataset 202. The classification head is typically implemented as a feed-forward neural network and a softmax layer, which outputs the probability score of the classes, although other implementations are contemplated.

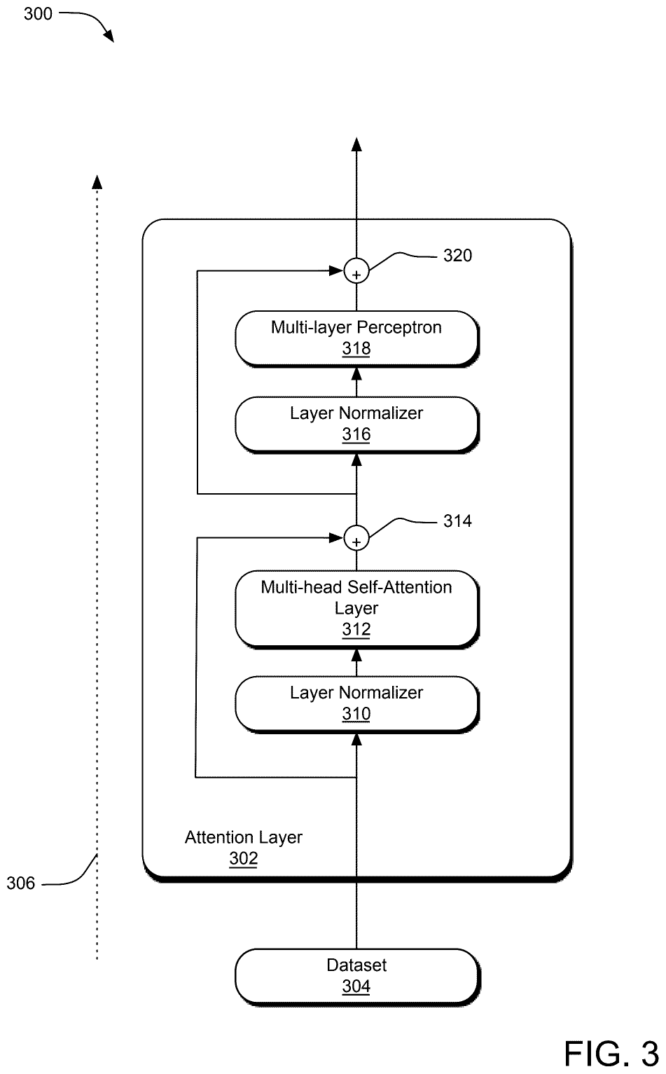

FIG. 3 illustrates an example flow 300 within an attention layer 302 for capturing local feature information from a dataset 304. The flow 300 in FIG. 3 progresses from bottom to top, as indicated by the dashed arrow 306. A dataset 304 (e.g., a gated embedding space from a previous layer) is input to the attention layer 302. The dataset 304 is (1) input to a sequence of operators including a layer normalizer 310 and a multi-head self-attention layer 312, and (2) fed forward to a summer 314. Layer normalizers normalize all the activations of a single layer from a batch by collecting statistics from every unit within the layer. The multi-head self-attention layer 312 includes multiple parallel attention mechanisms that process the dataset 304. The outputs of the multiple parallel attention mechanisms in the multi-head self-attention layer 312 are combined (e.g., concatenated and linearly transformed into the expected dimension) and passed to the summer 314, where the original dataset 304 is also added.

The resulting output of the summer 314 is (1) input to a sequence of operators including a layer normalizer 316 and a multi-layer perceptron 318 and (2) fed forward to a summer 320. The multi-layer perceptron 318 includes a feed-forward artificial neural network consisting of fully connected neurons with a nonlinear kind of activation function organized in multiple layers. Learning occurs in the multi-layer perceptron 318 by changing connection weights after each item of data is processed based on the amount of error in the output compared to the expected result. This is an example of supervised learning and is carried out through backpropagation, a generalization of the least mean squares algorithm in the linear perceptron. In this manner, the multi-layer perceptron 318 can distinguish data that is not linearly separable, thereby distinguishing and identifying local features in the dataset 304. The output of the multi-layer perceptron 318 is passed to the summer 320, where the output of the summer 314 is also added.

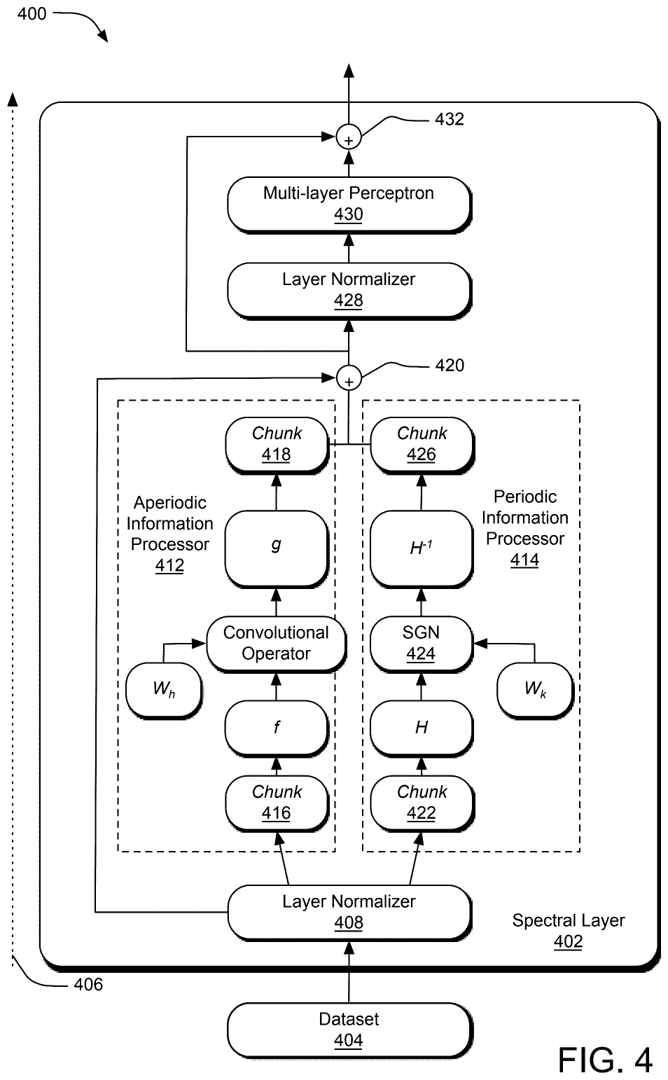

FIG. 4 illustrates an example flow 400 within a spectral layer 402 for capturing local feature information and global feature information from a dataset 404. The flow 400 in FIG. 4 progresses from bottom to top, as indicated by the dashed arrow 406.

The spectral layer 402 is designed to efficiently capture global and local features in the dataset 404 and, therefore, in the initial dataset. In one implementation, a layer 402 of the spectral processor begins the Hartley Transform (ψ) component, enabling the component to learn the global information of the dataset 404 using real frequency components. Meanwhile, the second part of the spectral layer undergoes processing through a convolutional operator to capture local image features. These two streams of data are subsequently merged to form a holistic feature representation that is normalized and then passed through a multi-layer perceptron (MLP) layer for classification. The input dataset (and the various gated datasets thereof) can be represented as periodic components and aperiodic components. In implementations, the periodic components can be modeled with the help of a Hartley neural operator (e.g., a Hartley convolutional transformer) to capture the global features of the dataset, and aperiodic components can be modeled using a convolutional neural operator to capture the local features of the dataset.

The dataset 404 (e.g., an embedding space of the original input dataset, a gated embedding space from a previous layer) is input to the spectral layer 402. The dataset 404 is (1) input to a sequence of operators including a layer normalizer 408, an aperiodic information processor 412, and a periodic information processor 414 and (2) fed forward to a summer 420.

The output of the layer normalizer 408 is split into multiple chunks of the dataset 404, each chunk being input to a different processor. In various implementations, the chunks are allocated in an arbitrary manner, are different and mutually exclusive of one another and/or combine to yield the full dataset 404 (e.g., the combinations of chunks include all of the information from the dataset 404).

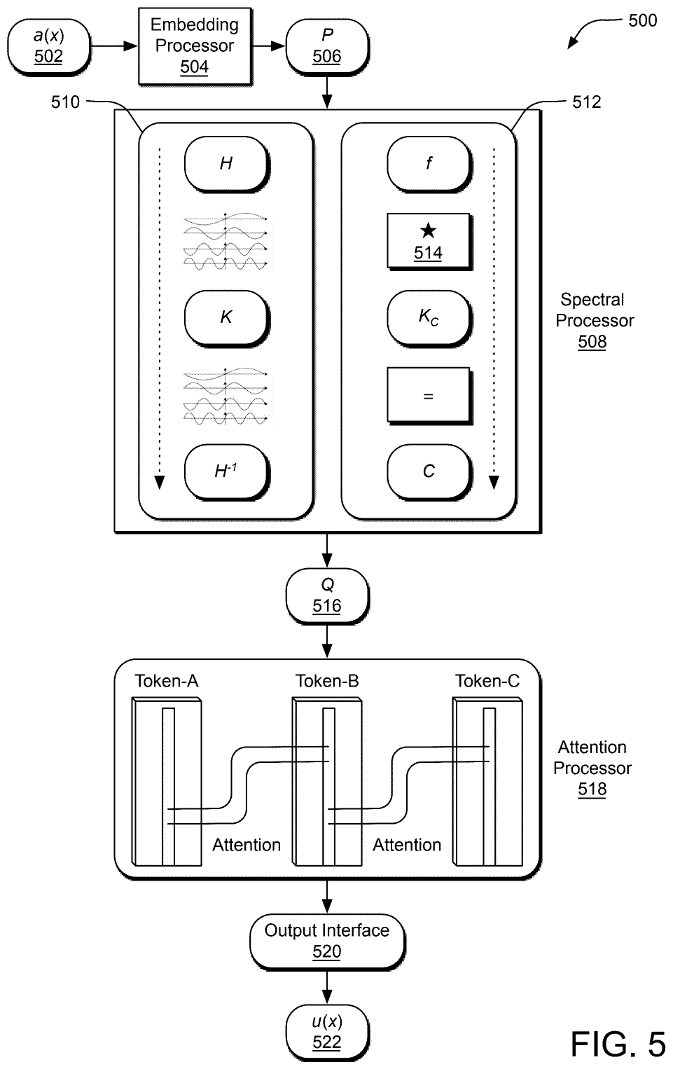

The aperiodic information processor 412 is configured to identify local features in the dataset 404 from an input chunk 416 taken from the dataset 404. A chunk includes a subset of the input dataset embedding. The dataset 404 may be an embedding space of the initial input dataset (e.g., the original image) or an embedding space of the output of a previous layer, which can be a derived version (e.g., a gated version) of the initial input dataset. The data in input chunk 416 is passed through a flow of the aperiodic information processor 412, as further described with respect to FIG. 5, resulting in an output chunk 418, which is output to the summer 420. Function g represents a function of the form y=mx+c, where m represents weights and constant c represents a bias term.

The periodic information processor 414 is configured to identify global features in the dataset 404 from a chunk 422 taken from the dataset 404. The data in the input chunk 416 is passed through a flow of the periodic information processor 412, as further described with respect to FIG. 5, including a spectral gating network 424 (SGN), resulting in a chunk 426, which is output to the summer 420. SGN is responsible for identifying how much spectral information will flow into subsequent layers.

The resulting output of the summer 420 is (1) input to a sequence of operators including a layer normalizer 428 and a multi-layer perceptron 430 and (2) fed forward to a summer 432. The output of the multi-layer perceptron 430 is passed to the summer 432, where the output of the summer 420 is also added. The output of the spectral layer 402 is passed along to a subsequent spectral layer or a subsequent attention layer.

FIG. 5. illustrates a model of an example system 500 for classifying a dataset a(x) 502. An embedding processor 504 embeds the dataset a(x) 502 in an embedding space P 506, which is input to a spectral processor 508. As previously described, in one implementation, a periodic processor layer 510 of the spectral processor 508 begins the Hartley Transform (ψ) component, enabling the component to learn the global information of the dataset using real frequency components. A Hartley transform can be compared to a Cosine transform. A Cosine transform uses a Cosine neural operator to learn a mapping between two infinite dimensional spaces from a finite collection of observed input-output pairs

$${\{ {a}_{j} , {u}_{j} \}}_{j = 1}^{N}$$

using a function A to function U

$$F : A \times Θ \to U .$$

### Equivalently,

$${F}_{θ} : A \to U , θ ∈ Θ .$$

A kind of Fourier neural operation may be used in the spectral processor 508. The input a∈A is projected to a higher dimensional representation v₀(x)=P(a(x)) by the local transformation P, which is usually parameterized by a shallow, fully connected neural network. Several iterations of vₜ→vₜ₊₁ updates are applied. The output u(x)=Q(v_{T}(x)) is the projection of v_{T} by the local transformation Q: [symbol] ^{d}^{ᵥ}→ [symbol] ^{d}^{ᵤ}. In each iteration, the update vₜ→vₜ₊₁ is defined as the composition of a non-local integral operator K and a local, nonlinear activation function σ. The iterative update to the representation vₜ→vₜ₊₁ by

$${v}_{t + 1} ( x ) = σ ( ( K ( a ; ϕ ) {v}_{t} ) ( x ) ) , ∀ x ∈ D \qquad ( 1 )$$

The Kernel integral operator K is defined by

$$( K ( a ; ϕ ) {v}_{t} ) ( x ) := {\int }_{D} k ( x , y , a ( x ) , a ( y ) ; ϕ ) {v}_{t} ( y ) dy , \qquad ( 2 )$$

where k_{ϕ} is a neural network parameterized by ϕ∈Θ_{K}. Here k_{ϕ} plays the role of a kernel function that the transform learns from the input data.

The kernel integral operator is replaced by a convolutional operator defined in Cosine space. Let ψ denote the Cosine transform of a function ƒ:D→R^{d}^{ᵥ} and let ψ⁻¹ denote its inverse, then

$${ψ}_{j} ( k ) = {\int }_{D} {f}_{j} ( x ) cos 〈 2 π k , x 〉 dx ,$$

$${ψ}_{j}^{- 1} ( x ) = \frac{1}{π} {\int }_{D} {f}_{j} ( k ) cos 〈 2 π k , x 〉 dk .$$

For the special case of the Green's kernel K(s, t)=K(s−t), the integral leads to global convolution. By applying k_{ϕ}(x, y, a(x), a(y))=k_{ϕ}(x−y) in Equation (2) and applying the convolution theorem, then

$$( K ( a : ϕ ) {v}_{t} ) ( x ) = {ψ}^{- 1} ( ψ ( {k}_{ϕ} ) \cdot ψ ( {v}_{t} ) ) ( x ) , ∀ x ∈ D .$$

The Cosine integral operator K is defined as

$$( K ( ϕ ) {v}_{t} ) ( x ) = {ψ}^{- 1} ( {R}_{ϕ} \cdot ( ψ {v}_{t} ) ) ( x ) ∀ x ∈ D \qquad ( 3 )$$

where R_{ϕ} is the real value Cosine transform of a periodic function k:D→R^{d}^{ᵥ}^{×d}^{ᵤ} parameterized by ϕ∈Θₖ.

Also, as previously described, in one implementation, an aperiodic processor layer 512 of the spectral processor 508 undergoes processing through one or more convolutional neural operator 514 to capture local image features. In various implementations, the one or more convolutional operators are performed with discrete kernels

$${K}_{c} = {\sum }_{i , j = 1}^{k} {k}_{i , j} {δ}_{{z}_{ij}} \qquad ( 4 )$$

defined on an s×s uniform grid with zᵢⱼ being the resulting grid points and δₓ is the Dirac measure at point x. The convolution operator of a single channel can be defined as

$${K}_{c} f ( x ) = ( {K}_{c} * f ) x = {\sum }_{i , j = 1}^{k} {k}_{ij} f ( x - {z}_{ij} ) . \qquad ( 5 )$$

The spectral processor 508, therefore, integrates two processing components: (1) the convolutional representation denoted by C=K_{c}ƒ(x), defined in Equation (5), and (2) the spectral representation V defined in Equation (1). This integration is formulated through the following expression:

$${V}_{t + 1} ( x ) = {C}_{t} ∘ σ ( ( K ( a ; ϕ ) {v}_{t} ) ( x ) ) , ∀ x ∈ D \qquad ( 6 )$$

where ∘ denotes the concatenation operation. Firstly, Cₜ, the convolutional representation is incorporated. Secondly, the spectral transformation involving the kernel function K parameterized by a and ϕ acts upon the previous representation vₜ. The output of the spectral processor 508 is specified by an embedding space Q 516.

An attention processor 518 includes a multi-headed self-attention followed by multi-layer perceptron layers. This combination of mechanisms facilitates the model's ability to capture complex relationships and patterns in the data. The attention heads of the model consist of the Query-Key (QK) circuit and the Output-Value (OV) circuit, both described below.

The Query-Key circuit computes attention scores between each query token and each key token. These attention scores determine how much a given query token wants to attend to a particular key token. The final representation is obtained using query and key vectors for the attention head by applying weight matrices W_{Q} and W_{K} to the input sequence X (i.e., kᵢ=W_{K}xᵢ, qᵢ=W_{Q}xᵢ). The attention scores are calculated using the dot product between the query and key vectors, followed by a softmax operation:

$$A = soft max ( {q}^{T} \cdot k ) = soft max ( {x}^{T} \cdot {W}_{Q}^{T} \cdot {W}_{K} \cdot x ) .$$

The Output-Value circuit determines how each token's information will affect the output log its if attended to. In statistics and machine learning, a log it is a quantile function associated with the standard logistic distribution. The value vectors by applying the weight matrix W_{V} to the input sequence X, vᵢ=xᵢ·W_{V}. The resulting vector for each token is computed by linearly combining value vectors based on the attention pattern:

$${ℛ}_{i} = {\sum }_{j} {A}_{i , j} \cdot {v}_{j} \qquad ( 7 )$$

The operation of the attention heads involves extracting information from the residual stream associated with a specific token and subsequently transmitting it to the residual stream connected with another token. In the first step, it extracts pertinent information from the residual stream of a designated token, and in the second step, it transits amassed information into the residual stream linked to a different token.

The output of the attention processor 518 is passed to an output interface 520 (e.g., a software interface, a hardware interface, or a combination of both software and hardware) as a dataset U(x) 522, a list of identified features of the input dataset a(x) 502.

The Hartley Convolution Neural Operator block combines the spectral representation V, as mentioned in equation (6), and the attention representation [symbol] , as mentioned in equation (7) and defined as

$$U ( x ) := ℛ ( V ( x ) ) , ∀ x ∈ D \qquad ( 8 )$$

The Combined Convolutional Neural Operator (CCNO) described herein introduces a novel hybrid approach by combining Discrete Hartley Transformation (DCT) or Discrete Cosine Transformation (DCT) with convolutional nets in initial layers and integrating self-attention in deeper layers. This architecture allows CCNO to effectively capture both global and local information representations, addressing a key limitation of traditional transformers with O(n2) complexity. Particularly, CCNO-S achieves state-of-the-art performance on ImageNet with an impressive 84.5% top-1 accuracy, while the larger variant, CCNO-L, shows notable results at 85.8% m and CCNO-H has reached 86.4%, which is the highest accuracy achieved in ImageNet 1K with 150 million parameters, which is an order of magnitude lesser number of parameters compared to ViT-22B, which requires billions of parameters. Extending beyond classification tasks, an evaluation of object detection and image segmentation using the MS-COCO dataset further validates the efficacy of CCNO across various computer vision applications. The unified architecture of CCNO, combining spectral transformations with convolutions and attention mechanisms, addresses the local-global trade-off and offers a promising direction for advancing deep learning in computer vision.

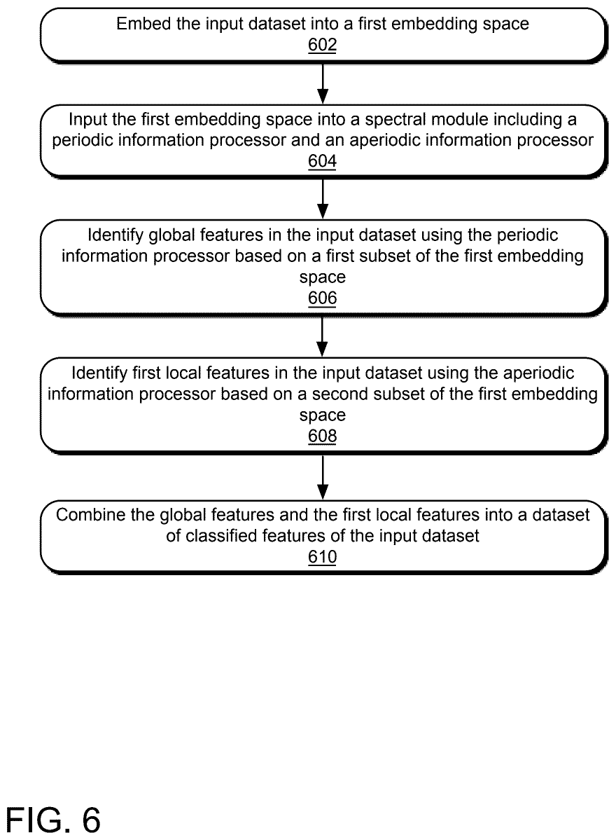

FIG. 6 illustrates example operations 600 for classifying a dataset. An embedding operation 602 embeds the input dataset into a first embedding space. A spectral processing operation 604 inputs the first embedding space into a spectral module that includes a periodic information processor and an aperiodic information processor. A periodic information processing operation 606 identifies global features in the input dataset using the periodic information processor based on a first subset of the first embedding space. An aperiodic information processing operation 608 identifies local features in the input dataset using the aperiodic information processor based on a second subset of the first embedding space. The first subset and the second subset are different. An output operation 610 combines the global features and the first local features into a dataset of classified features of the input dataset.

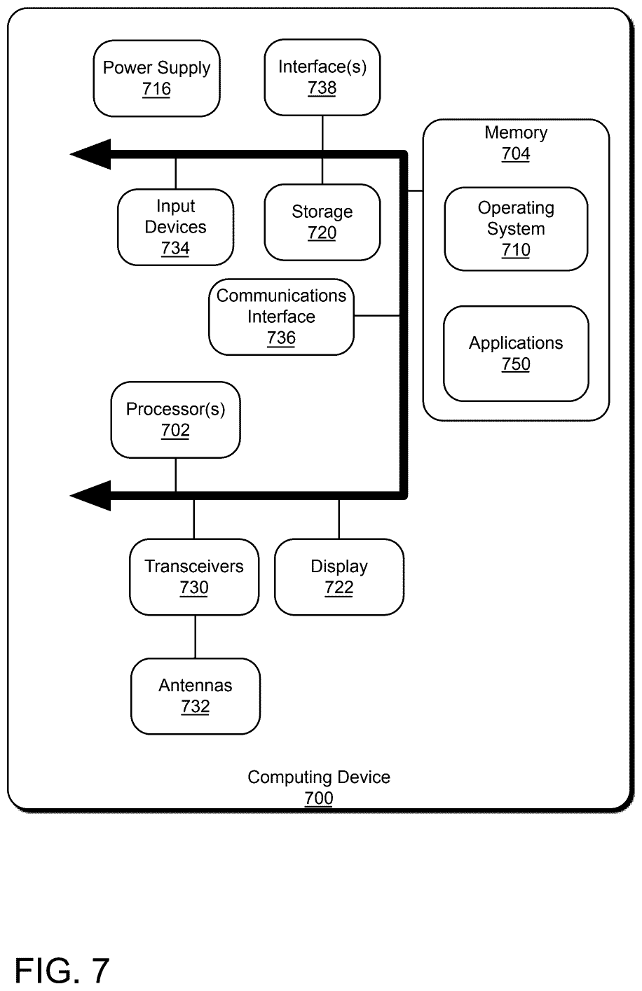

FIG. 7 illustrates an example computing device 700 for use in implementing the described technology. The computing device 700 may be a client computing device (such as a laptop computer, a desktop computer, or a tablet computer), a server/cloud computing device, an Internet-of-Things (IoT), any other type of computing device, or a combination of these options. The computing device 700 includes one or more hardware processor(s) 702 and a memory 704. The memory 704 generally includes both volatile memory (e.g., RAM) and nonvolatile memory (e.g., flash memory), although one or the other type of memory may be omitted. An operating system 710 resides in the memory 704 and is executed by the processor(s) 702. In some implementations, the computing device 700 includes and/or is communicatively coupled to storage 720.

In the example computing device 700, as shown in FIG. 7, one or more software modules, segments, and/or processors, such as applications 750, a transformer, linear projection layers, position embedders, spectral layers, spectral processors, attention layers, attention processors, attention layers, attention networks, processing modules, classifier heads, layer normalizers, multi-layer perceptrons, multi-head self-attention layers, convolutional operators, spectral gating networks, embedding processors, output interfaces, and other program code and modules are loaded into the operating system 710 on the memory 704 and/or the storage 720 and executed by the processor(s) 702. The storage 720 may store an input dataset, a dataset of identified features, embedding spaces, chunks, weights, and other data and be local to the computing device 700 or may be remote and communicatively connected to the computing device 700. In particular, in one implementation, components of a system for classifying a dataset may be implemented entirely in hardware or in a combination of hardware circuitry and software.

The computing device 700 includes a power supply 716, which may include or be connected to one or more batteries or other power sources, and which provides power to other components of the computing device 700. The power supply 716 may also be connected to an external power source that overrides or recharges the built-in batteries or other power sources.

The computing device 700 may include one or more communication transceivers 730, which may be connected to one or more antenna(s) 732 to provide network connectivity (e.g., mobile phone network, Wi-Fi®, Bluetooth®) to one or more other servers, client devices, IoT devices, and other computing and communications devices. The computing device 700 may further include a communications interface 736 (such as a network adapter or an I/O port, which are types of communication devices). The computing device 700 may use the adapter and any other types of communication devices for establishing connections over a wide-area network (WAN) or local-area network (LAN). It should be appreciated that the network connections shown are exemplary and that other communications devices and means for establishing a communications link between the computing device 700 and other devices may be used.

The computing device 700 may include one or more input devices 734 such that a user may enter commands and information (e.g., a keyboard, trackpad, or mouse). These and other input devices may be coupled to the server by one or more interfaces 738, such as a serial port interface, parallel port, or universal serial bus (USB). The computing device 700 may further include a display 722, such as a touchscreen display.

The computing device 700 may include a variety of tangible processor-readable storage media and intangible processor-readable communication signals. Tangible processor-readable storage can be embodied by any available media that can be accessed by the computing device 700 and can include both volatile and nonvolatile storage media and removable and non-removable storage media. Tangible processor-readable storage media excludes intangible, transitory communications signals (such as signals per se) and includes volatile and nonvolatile, removable and non-removable storage media implemented in any method, process, or technology for storage of information such as processor-readable instructions, data structures, program modules, or other data. Tangible processor-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage, or other magnetic storage devices, or any other tangible medium which can be used to store the desired information and which can be accessed by the computing device 700. In contrast to tangible processor-readable storage media, intangible processor-readable communication signals may embody processor-readable instructions, data structures, program modules, or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

Clause 1. A method of classifying an input dataset, the method comprising: embedding the input dataset into a first embedding space; inputting the first embedding space into a spectral module including a periodic information processor and an aperiodic information processor; identifying global features in the input dataset using the periodic information processor based on a first subset of the first embedding space; identifying first local features in the input dataset using the aperiodic information processor based on a second subset of the first embedding space, wherein the first subset and the second subset are different; and combining the global features and the first local features into a dataset of classified features of the input dataset.

Clause 2. The method of clause 1, further comprising: identifying second local features in the input dataset using an attention processor based on output of the spectral module; and combining the second local features with the global features and the first local features in the dataset of the classified features of the input dataset.

Clause 3. The method of clause 1, wherein the periodic information processor identifies global features in the input dataset using a frequency domain.

Clause 4. The method of clause 3, wherein the periodic information processor translates the first embedding space from a spatial domain into the frequency domain using a Hartley transformation, identifies at least one of the global features using a spectral gating network, and applies an inverse Hartley transformation to translate the first embedding space from the frequency domain to the spatial domain.

Clause 5. The method of clause 1, wherein the aperiodic information processor identifies local features in the input dataset using at least one Hartley convolutional transformer.

Clause 6. The method of clause 1, wherein the first subset and the second subset are mutually exclusive.

Clause 7. The method of clause 1, wherein the first subset and the second subset combine to yield the input dataset.

Clause 8. A computing system for classifying an input dataset, the computing system comprising: one or more hardware processors; an embedding processor executable by one or more hardware processors and configured to embed the input dataset into a first embedding space; a spectral processor executable by the one or more hardware processors and configured to input the first embedding space into a spectral module including a periodic information processor and an aperiodic information processor, wherein the periodic information processor is configured to identify global features in the input dataset based on a first subset of the first embedding space and the aperiodic information processor is configured to identify first local features in the input dataset based on a second subset of the first embedding space, wherein the first subset and the second subset are different; and an output interface executable by the one or more hardware processors and configure to combine the global features and the first local features into a dataset of classified features of the input dataset.

Clause 9. The computing system of clause 8, wherein the spectral processor outputs a second embedding space and further comprising: an attention processor executable by the one or more hardware processors and configured to identify second local features in the input dataset using attention processing based on the second embedding space, wherein the output interface is further configured to combine the second local features with the global features and the first local features in the dataset of the classified features of the input dataset.

Clause 10. The computing system of clause 8, wherein the periodic information processor identifies global features in the input dataset using a frequency domain.

Clause 11. The computing system of clause 10, wherein the periodic information processor is configured to translate the first embedding space from a spatial domain into the frequency domain using a neural operator, identify at least one of the global features using a spectral gating network, and apply an inverse transformation to translate the first embedding space from the frequency domain to the spatial domain.

Clause 12. The computing system of clause 8, wherein the aperiodic information processor identifies local features in the input dataset using at least one convolutional operator.

Clause 13. The computing system of clause 8, wherein the input dataset is an image.

Clause 14. The computing system of clause 8, wherein the first subset and the second subset combine to yield the input dataset.

Clause 15. One or more tangible processor-readable storage media embodied with instructions for executing on one or more processors and circuits of a computing device a process for classifying an input dataset, the process comprising: embedding the input dataset into a first embedding space; inputting the first embedding space into a spectral module including a periodic information processor and an aperiodic information processor; identifying global features in the input dataset using the periodic information processor based on a first subset of the first embedding space; identifying first local features in the input dataset using the aperiodic information processor based on a second subset of the first embedding space; and combining the global features and the first local features into a dataset of classified features of the input dataset.

Clause 16. The one or more tangible processor-readable storage media of clause 15, wherein the process further comprises: identifying second local features in the input dataset using an attention processor based on output of the spectral module; and combining the second local features with the global features and the first local features in the dataset of the classified features of the input dataset.

Clause 17. The one or more tangible processor-readable storage media of clause 15, wherein the periodic information processor identifies global features in the input dataset using a frequency domain.

Clause 18. The one or more tangible processor-readable storage media of clause 17, wherein the periodic information processor translates the first embedding space from a spatial domain into the frequency domain using a Hartley Transformation, identifies at least one of the global features using a spectral gating network, and applies an Inverse Hartley Transformation to translate the first embedding space from the frequency domain to the spatial domain.

Clause 19. The one or more tangible processor-readable storage media of clause 15, wherein the aperiodic information processor identifies local features in the input dataset using at least one convolutional operator.

Clause 20. The one or more tangible processor-readable storage media of clause 15, wherein the first subset and the second subset are mutually exclusive and combine to yield the input dataset.

Clause 21. A system for classifying an input dataset, the system comprising: means for embedding the input dataset into a first embedding space; means for inputting the first embedding space into a spectral module including a periodic information processor and an aperiodic information processor; means for identifying global features in the input dataset using the periodic information processor based on a first subset of the first embedding space; means for identifying first local features in the input dataset using the aperiodic information processor based on a second subset of the first embedding space, wherein the first subset and the second subset are different; and means for combining the global features and the first local features into a dataset of classified features of the input dataset.

Clause 22. The system of clause 21, further comprising: means for identifying second local features in the input dataset using an attention processor based on output of the spectral module; and means for combining the second local features with the global features and the first local features in the dataset of the classified features of the input dataset.

Clause 23. The system of clause 21, wherein the periodic information processor identifies global features in the input dataset using a frequency domain.

Clause 24. The system of clause 23, wherein the periodic information processor translates the first embedding space from a spatial domain into the frequency domain using a Hartley transformation, identifies at least one of the global features using a spectral gating network, and applies an inverse Hartley transformation to translate the first embedding space from the frequency domain to the spatial domain.

Clause 25. The system of clause 21, wherein the aperiodic information processor identifies local features in the input dataset using at least one Hartley convolutional transformer.

Clause 26. The system of clause 21, wherein the first subset and the second subset are mutually exclusive.

Clause 27. The system of clause 1, wherein the first subset and the second subset combine to yield the input dataset.

Some implementations may comprise an article of manufacture, which excludes software per se. An article of manufacture may comprise a tangible storage medium to store logic and/or data. Examples of a storage medium may include one or more types of computer-readable storage media capable of storing electronic data, including volatile memory or nonvolatile memory, removable or non-removable memory, erasable or non-erasable memory, writeable or re-writeable memory, and so forth. Examples of the logic May include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described embodiments. The executable computer program instructions may include any suitable types of code, such as source code, compiled code, interpreted code, executable code, static code, dynamic code, and the like. The executable computer program instructions may be implemented according to a predefined computer language, manner, or syntax, for instructing a computer to perform a certain operation segment. The instructions may be implemented using any suitable high-level, low-level, object-oriented, visual, compiled, and/or interpreted programming language.

The implementations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language.

What is claimed is:

1. A method of classifying an input dataset, the method comprising:
embedding the input dataset into a first embedding space;
inputting the first embedding space into a spectral module including a periodic information processor and an aperiodic information processor;
identifying global features in the input dataset using the periodic information processor based on a first subset of the first embedding space;
identifying first local features in the input dataset using the aperiodic information processor based on a second subset of the first embedding space, wherein the first subset and the second subset are different; and
combining the global features and the first local features into a dataset of classified features of the input dataset.

2. The method of claim 1, further comprising:
identifying second local features in the input dataset using an attention processor based on output of the spectral module; and
combining the second local features with the global features and the first local features in the dataset of the classified features of the input dataset.

3. The method of claim 1, wherein the periodic information processor identifies global features in the input dataset using a frequency domain.

4. The method of claim 3, wherein the periodic information processor translates the first embedding space from a spatial domain into the frequency domain using a Hartley transformation, identifies at least one of the global features using a spectral gating network, and applies an inverse Hartley transformation to translate the first embedding space from the frequency domain to the spatial domain.

5. The method of claim 1, wherein the aperiodic information processor identifies local features in the input dataset using at least one Hartley convolutional transformer.

6. The method of claim 1, wherein the first subset and the second subset are mutually exclusive.

7. The method of claim 1, wherein the first subset and the second subset combine to yield the input dataset.

8. A computing system for classifying an input dataset, the computing system comprising:
one or more hardware processors;
an embedding processor executable by one or more hardware processors and configured to embed the input dataset into a first embedding space;
a spectral processor executable by the one or more hardware processors and configured to input the first embedding space into a spectral module including a periodic information processor and an aperiodic information processor, wherein the periodic information processor is configured to identify global features in the input dataset based on a first subset of the first embedding space and the aperiodic information processor is configured to identify first local features in the input dataset based on a second subset of the first embedding space, wherein the first subset and the second subset are different; and
an output interface executable by the one or more hardware processors and configure to combine the global features and the first local features into a dataset of classified features of the input dataset.

9. The computing system of claim 8, wherein the spectral processor outputs a second embedding space and further comprising:
an attention processor executable by the one or more hardware processors and configured to identify second local features in the input dataset using attention processing based on the second embedding space, wherein the output interface is further configured to combine the second local features with the global features and the first local features in the dataset of the classified features of the input dataset.

10. The computing system of claim 8, wherein the periodic information processor identifies global features in the input dataset using a frequency domain.

11. The computing system of claim 10, wherein the periodic information processor is configured to translate the first embedding space from a spatial domain into the frequency domain using a neural operator, identify at least one of the global features using a spectral gating network, and apply an inverse transformation to translate the first embedding space from the frequency domain to the spatial domain.

12. The computing system of claim 8, wherein the aperiodic information processor identifies local features in the input dataset using at least one convolutional operator.

13. The computing system of claim 8, wherein the input dataset is an image.

14. The computing system of claim 8, wherein the first subset and the second subset combine to yield the input dataset.

15. One or more tangible processor-readable storage media embodied with instructions for executing on one or more processors and circuits of a computing device a process for classifying an input dataset, the process comprising:
embedding the input dataset into a first embedding space;
inputting the first embedding space into a spectral module including a periodic information processor and an aperiodic information processor;
identifying global features in the input dataset using the periodic information processor based on a first subset of the first embedding space;
identifying first local features in the input dataset using the aperiodic information processor based on a second subset of the first embedding space; and
combining the global features and the first local features into a dataset of classified features of the input dataset.

16. The one or more tangible processor-readable storage media of claim 15, wherein the process further comprises:
identifying second local features in the input dataset using an attention processor based on output of the spectral module; and
combining the second local features with the global features and the first local features in the dataset of the classified features of the input dataset.

17. The one or more tangible processor-readable storage media of claim 15, wherein the periodic information processor identifies global features in the input dataset using a frequency domain.

18. The one or more tangible processor-readable storage media of claim 17, wherein the periodic information processor translates the first embedding space from a spatial domain into the frequency domain using a Hartley Transformation, identifies at least one of the global features using a spectral gating network, and applies an Inverse Hartley Transformation to translate the first embedding space from the frequency domain to the spatial domain.

19. The one or more tangible processor-readable storage media of claim 15, wherein the aperiodic information processor identifies local features in the input dataset using at least one convolutional operator.

20. The one or more tangible processor-readable storage media of claim 15, wherein the first subset and the second subset are mutually exclusive and combine to yield the input dataset.
